(19) United States
(12) Patent Application Publication
(10) Pub. No.: US 2013/0342729 A1
(43) Pub. Date: Dec. 26, 2013

(54) METHOD AND APPARATUS FOR PROCESSING IMAGE DATA IN TERMINAL

(71) Applicant: Samsung Electronics Co. Ltd., Suwon-si (KR)

(72) Inventors: Dongjeon KIM, Anyang-si (KR); Kyungrok KIM, Seoul (KR); Kiseon KIM, Gwacheon-si (KR); Zunho LEE, Seongnam-si (KR); Chulhwan LEE, Seoul (KR); Sunghyuk SHIN, Seongnam-si (KR); Hyunjung KIM, Seoul (KR)

(21) Appl. No.: 13/918,074

(22) Filed: Jun. 14, 2013

(30) Foreign Application Priority Data
Jun. 22, 2012 (KR) 10- 2012-0067235

(51) Int. Cl. H04N 5/77; H04N 5/232

(52) U.S. Cl. CPC H04N 5/772; H04N 5/23293
USPC 348/231.3

(57) ABSTRACT

A method for processing a photo image in a terminal comprises displaying a photo image if photographing is requested in a preview mode, setting a touch memo area by rearranging the displayed photo image, generating an edited photo image by displaying a pen touch input in the touch memo area, and storing the edited photo image by combining with a touch memo.

### CROSS-REFERENCE TO RELATED APPLICATION

This application claims priority from Korean Patent Application No. 10-2012-0067235 filed on Jun. 22, 2012 in the Korean Intellectual Property Office, the entire disclosure of which is hereby incorporated by reference.

### BACKGROUND

1. Field

Methods and apparatuses consistent with exemplary embodiments relate to a method and an apparatus for processing image data in a terminal and, more particularly, to a method and an apparatus for recording a memo in a photo image.

2. Description of the Related Art

A conventional terminal is equipped with a camera, and a photo taken by the camera may be stored in a memory or transferred to an external device through a communication unit. When taking and storing a photo, the terminal stores the photo with photographing information (For example, EXIF; Exchangeable Image File), where the photographing information may include a photographing date and time, color space, focal distance, flash setting, ISO speed, aperture, and shutter speed. Further, the photographing information may include information of a location where a photo is taken. When storing the photo, a file name input through an input device is stored with the photo.

However, the photographing information stored with the photo is information obtained automatically by a sensor, and therefore a user's feeling or a situation related to the photographing cannot be recorded with the photo taken by the camera or stored in the terminal Therefore, the user must record the feeling or the situation manually with a notebook and a pen, or must record the feeling or the situation in the terminal separately from the photo. In this case, the photo and the photographing information are stored separately, and the user may experience inconvenience because the user must combine the photo and the photographing information by processing with a computer.

### SUMMARY

An exemplary embodiment provides a method and an apparatus for combining a touch memo of a user input with a photo taken by a terminal having a camera and a touch panel, and for editing the photo.

The exemplary embodiment provides a method and an apparatus for displaying a photo taken by a terminal, setting a memo area by rearranging the image of the displayed photo, displaying a touch memo in the set memo area, and storing the displayed photo with the touch memo if editing is completed. The present invention further provides a method and an apparatus for setting a memo area by rearranging an image in a state of displaying a stored image, displaying a touch memo in the set memo area, and storing the displayed photo with the memo if editing is completed.

An exemplary embodiment provides a method for processing an image in a terminal, the method comprising: displaying the image; setting a memo area by rearranging the displayed image; generating an edited image by displaying an input in the memo area; and storing the edited image by combining with a memo. The image may comprise a photo image and the input may comprise a pen touch input.

In the operation of displaying the image, the image may comprise an image displayed in a preview mode while photographing.

The operation of setting the memo area may comprise: moving the image in a direction of a slide gesture if the slide gesture is detected as an edit gesture; and replacing the area the image is moved from with the memo area.

The slide gesture may be a scroll touch by a pen, and the movement direction of the scroll touch may be one from among upward, downward, leftward, and rightward directions.

The size and location of the moved image may be adjusted.

The storing the edited image may comprise storing an original image and the edited image.

The operation of displaying the image may comprise: displaying a movement direction of a slide gesture if the slide gesture is detected as an edit gesture; displaying the memo area by adjusting a transparency of a setting area according to the movement direction and distance of the slide gesture; and displaying the input in the memo.

The slide gesture may be a scroll touch by a pen, and the direction of the scroll touch may be one from among upward, downward, leftward, and rightward directions.

The storing the edited image may comprise storing an original image, a location of the memo area, and the memo together.

The operation of setting the memo area may comprise: flipping the image displayed in a location of a flip gesture if the flip gesture is detected as an edit gesture; and setting the memo area by adjusting a transparency of the area of the flipped image.

The flip gesture may be generated by the pen, and the flipping the image may be an operation of reversing or folding the image.

The operation of storing an edited image may comprise storing an original image, a location of the memo area, and the memo.

Another exemplary embodiment provides an apparatus for processing the image in a terminal The apparatus comprises a camera which obtains the image; a storage unit which stores the image; a touch panel which detects a touch input; a controller configured to control a display of the image obtained by the camera, set a touch memo area by rearranging the displayed image if an edit gesture is detected in the touch panel, display the touch input in the touch memo area, and store the image in the storage by combining the image with a touch memo; and a display which displays the image and the touch memo under the control of the controller. The touch input may be a pen touch input and the image may comprise a photo image.

The displayed image may comprise an image displayed in a preview mode while photographing.

The controller controls to move the image displayed in the display if a slide gesture is detected as an edit gesture, controls to set an area of the moved image as the touch memo area, and controls to display the touch input through the touch panel in the touch memo area.

The controller may control to display the touch memo area by adjusting a transparency of the set area according to a movement direction and distance of the slide gesture if the slide gesture is detected as an edit gesture, and control to display the touch input as a touch memo in the touch memo area.

The controller may control to flip the image displayed in a location of a flip gesture if the flip gesture is detected as an edit gesture, control to set an area of the flipped image as a touch memo area by adjusting the transparency of the area of the flipped image, and control to display the touch input in the touch memo area.

Therefore, a user's feeling or a situation of photographing in a memo form can be stored with a photo while taking the photo with a terminal having a camera and a touch panel, and any desired record can be edited easily in the photo. Further, a new memo such as a remembrance of a photo may be added to an existing memo while the photo stored in the terminal is being displayed. When recording a memo in a photo, the photo can freely be rearranged by an edit gesture, and thereby the memo in the photo image can be edited in a various form.

### BRIEF DESCRIPTION OF THE DRAWINGS

The features and advantages of the exemplary embodiments will be more apparent from the following detailed description in conjunction with the accompanying drawings, in which:

FIG. 1 is a block diagram of a terminal according to an exemplary embodiment;

FIG. 2 is a flow chart of a procedure combining a touch memo with a photo image taken by a terminal according to another exemplary embodiment;

FIG. 3 is a flow chart of a procedure editing a touch memo in a photo image if an edit gesture is generated according to an exemplary embodiment;

FIGS. 4A to 4E are screen views illustrating examples of editing a photo image according to a slide edit gesture;

FIGS. 5A to 5E are screen views illustrating alternative examples of editing a photo image according to a slide edit gesture;

FIGS. 6A to 6C are screen views illustrating examples of editing a photo image according to a flip edit gesture; and

FIG. 7 is a flow chart of another procedure combining a touch memo with a photo image taken by a terminal according to an exemplary embodiment.

### DETAILED DESCRIPTION OF EXEMPLARY EMBODIMENTS

Hereinafter, exemplary embodiments are described in detail with reference to the accompanying drawings. The same reference symbols are used throughout the drawings to refer to the same or like parts. Detailed descriptions of well-known functions and structures incorporated herein may be omitted to avoid obscuring the subject matter of the exemplary embodiments.

In this description, a term “touch memo” represents information input through a touch panel by a terminal user, such as a pen touch input, finger touch input and/or keypad input. The touch memo may further include a script character, non-character pattern (such as a figure, picture, line, and icon), and multimedia data. A term “edit gesture” represents a user input performed in an edit mode in which a touch memo may be prepared on a displayed photo. Here, the edit gesture may be an interaction commencing an edit mode and/or an interaction rearranging an image displayed on a screen. The edit gesture may further include a pen gesture, hand gesture, and motion or hovering detected by a camera and/or by a motion sensor. A term “slide gesture” as an edit gestures represents a touch interaction setting a display area of a touch memo by moving a photo in a planar direction or by overlaying the touch memo on the photo in a coplanar form. A term “flip gesture” as an edit gesture represents a touch interaction setting a display area of a touch memo on the backside of a photo by reversing the photo, and may include actions such as folding a photo, reversing a photo, and rolling a photo. A term “touch panel” represents a panel detecting a touch input through a finger and/or a pen, and may include a pressure sensitive touch panel, electrostatic touch panel, and Electro Magnetic Resonance (EMR) touch panel.

An exemplary embodiment displays a photo taken by a terminal having a touch panel and a camera, sets a display area of a touch memo by rearranging the photo if an edit gesture is generated, displays an input touch memo in the set display area, and stores the touch memo and the rearranged photo image if preparing the memo is completed. Here, the photo image may be an image displayed in a preview mode while photographing with the camera.

In addition, an exemplary embodiment sets a display area of a touch memo by rearranging a photo in a state of displaying the photo if an edit gesture is generated in a terminal having a touch panel, displays an input touch memo in the set touch memo area, and stores the displayed photo with the memo if preparing the memo is completed

Here, the touch memo may be input through a touch pen. The edit gesture may include a slide gesture for setting the display area of the touch memo by moving the photo in a planar direction and a flip gesture for setting the display area of the touch memo by reversing the photo. If a slide gesture is generated, a method for setting an area in which the touch memo is to be displayed may be performed by moving and/or adjusting the photo in a planar direction or by overlaying the touch memo on the photo in a coplanar form. If a flip gesture is generated, the method for setting an area in which the touch memo is to be displayed may be performed by reversing the photo, folding the photo, or rolling the photo.

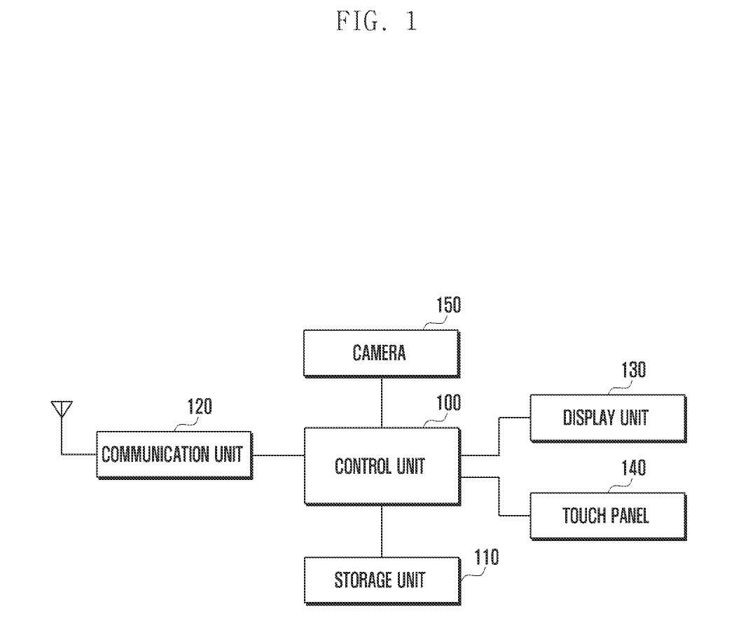

FIG. 1 is a block diagram of a terminal according to an exemplary embodiment. The terminal is a mobile terminal, and may include various digital equipment such as a mobile phone (including a smart phone), tablet, and laptop computer.

Referring to FIG. 1, a communication unit 120 performs a wireless communication function with a base station or with other wireless equipment. The communication unit 120 may be a radio frequency (RF) communication unit provided with a transmitter up-converting a frequency and amplifying an electric power of a transmitting signal, and a receiver low-noise amplifying and down-converting a frequency of a receiving signal. The communication unit 120 may further be provided with a modulator and a demodulator. The modulator modulates the transmitting signal and transmits it to the transmitter, and demodulator demodulates the receiving signal taken through the receiver. In this case, the modulator and demodulator may be a 3GPP Long Term Evolution (LTE), Wideband Code Division Multiple Access (WCDMA), Global Systems for Mobile Communications (GSM), WIFI, or Wireless Broadband (WIBRO). The communication unit 120 may perform a wireless communication function in corresponding networks by connecting to a public wireless communication network and/or to the Internet. In an exemplary embodiment, the communication unit 120 may be provided with an LTE communication unit enabling communication with an LTE base station and a WIFI communication unit.

A control unit 100 controls overall operation of a mobile terminal, and, according to the exemplary embodiment, sets an area in which a touch memo is to be displayed on a photo if an edit gesture is detected, controls to display an input touch memo with the photo in the set area, and controls to store the touch memo and the photo if preparation of a memo is completed. The control unit 100 may have an application processor performing an application of the terminal and a communication processor. In the case of having a communication processor, a modem modulating a transmitting signal and demodulating a receiving signal may be provided in the communication processor.

A storage unit 110 may have a program memory storing an operation program of the terminal and a program according to the exemplary embodiment, and a data memory storing data tables for the operation of the terminal and data generated during the execution of the program. In particular, the storage unit 110 is configured with a gallery for storing photos, and may store a photo containing a memo according to the exemplary embodiment under the control of the control unit 100.

A display unit 130 displays application information during the execution of the program under the control of the control unit 100. The display unit 130 may be a liquid crystal display (LCD) or an organic light-emitting diode (OLED). A touch panel 140 may be a pressure sensitive type, electrostatic type, and/or EMR type, and detects a user touch and/or a pen touch. Hereafter, the touch panel 140 is assumed to have both an electrostatic panel and an EMR panel. In this case, the electrostatic panel of the touch panel 140 may detect a user's finger touch input, and the EMR panel of the touch panel 140 may detect a pen touch input. Here, the display unit 130 and the touch panel 140 may be configured as an integral touch screen.

A camera 150 performs a function of obtaining an image under the control of the control unit 100. The camera 150 may have an image sensor, optical unit, and image signal processor, and an output of the camera 150 may be processed under the control of an application processor (AP). Alternatively, if the camera 150 has an image sensor and an optical unit, the image signal processor may be provided in the application processor of the control unit 110.

In the terminal having the above composition, the control unit 100 obtains a photo image by controlling the camera 150. Here, the photo image may be a still image or a moving image. The terminal according to the exemplary embodiment may compose a photo image with a touch memo input in an edit mode. In composing the photo image, not only is the composed photo image stored in metadata, but also the touch memo is stored in metadata. Therefore, information such as a date and time, user's feeling, and situation of photographing may be recorded or stored.

A situation of photographing, a situation after photographing, and a user's feeling of a photo may be recorded on the photo as a memo. The memo may be prepared through the touch panel 140, and more particularly, may be prepared freely in the case of using a terminal having a pen. Here, the memo corresponds to a touch memo. For this, the touch panel 140 may be provided with a touch panel for detecting a user's finger touch input and a touch panel for detecting a pen touch input, and these touch panels may be configured independently. In an exemplary embodiment, it is assumed that the touch panel 140 is configured with an electrostatic panel for detecting a finger touch input and an EMR panel for detecting a touch input of an electronic pen.

The electrostatic panel using a method of detecting a minute electric current flowing in a human body enables a multi-touch input, and may be used with a finger or with a special pen generating an electrostatic current. The EMR panel using a method of detecting an electromagnetic signal generated by a touch sensor and by a dedicated pen may identify pen pressure intensity, and enables operations of right and left clicks like a mouse. The EMR panel further enables a fine operation like a brush by measuring the pen pressure intensity, and enables coordinates movement if the pen approaches close to a screen without having to touch the screen. The display unit 130 and the touch panel 140 may be configured as an integrated unit, and in this case, the display unit 130 may be designed in a structure having an electrostatic panel on the top of the display unit 130 and an EMR panel at the bottom of the display unit 130.

Hereafter, detailed descriptions will be made assuming that the touch memo is prepared by a pen touch input. However, the touch memo may be prepared by a finger touch input or by both the pen touch input and the finger touch input. The photo image is assumed to be a still image, and an example of composing a memo by setting a memo area on the still image will be described. However, the same method may be applied to a moving image.

In the terminal having the above composition, if a user requests operation of the camera 150, the control unit 100 performs a preview mode and controls to display an image taken by the camera 150 on the display unit 130. If the user requests photographing (i.e. shutter switch on) in the preview mode, the control unit 100 controls to display the image output by the camera 150 on the display unit 130 as a still image, and controls to store the displayed still image in the storage unit 110 if storing the still images is requested.

In a state of displaying the still image in the display unit 130, if the user generates an edit gesture, the control unit 100 detects it through the touch panel 140 and controls the display unit 130 to set a display area of a touch memo by rearranging the displayed photo image. Therefore, the edit gesture may be a predefined specific gesture, predefined touch pattern (for example, a rotation touch, flick, and touch at a specific point), and a specific action detected by a camera and/or by a motion sensor. In the state of displaying the photo image, the control unit 100 controls the display unit 130 to display items for preparing the touch memo, activates an edit mode if a corresponding icon is touched, and sets a memo area according to a generated gesture. In the exemplary embodiment, it is assumed that the edit gesture is performed by a scroll action (slide gesture) or by a rotation touch action (flip gesture) at a specific location, using a pen in a state of displaying a photo. However, the edit gesture may be performed by a different type of pen and/or finger touch detected through the touch panel 140, and also by a specific terminal's action and/or a user action detected through the motion sensor (not shown) and the camera 150.

As described above, if an edit gesture is generated, the control unit 100 sets a display area of a touch memo by rearranging the photo image displayed in the display unit 130, and controls to display a touch input detected by the touch panel 140 in a corresponding area as a touch memo. In a case of a pen touch input, the touch memo may be a script character including a numeral and/or non-character information (for example, a figure, picture, and line), and the control unit 100 may control to display the touch memo in the display unit 130. In the state of displaying the touch memo, the control unit 100 may control to display items for composing the touch memo with a photo image. Here, the items may be represented as an icon or in a soft button form, and may include an item of ‘completion of editing’ for storing the touch memo with the photo image. Further, a rolling gesture item for reversing a photo may be represented as an icon.

In the preview mode, if an edit gesture is detected, the control unit 100 controls to capture a photo image in focus by switching to a memo edit mode, and sets an area for displaying an input touch memo by rearranging the captured photo image. In the above state, if an input memo is generated, the control unit 100 composes the input memo with the photo image, and controls to store an edited photo image in the storage unit 110 if a storing action is requested. Namely, if an edit gesture is detected even in a preview mode for focusing on a subject, the control unit 100 switches to a memo edit mode, and controls to capture a new photo image in focus and to store the captured photo image by combining with a memo.

While executing a video mode for taking a moving image, if an edit gesture is generated, the control unit 100 sets an area for displaying a touch memo as a partial view in the display unit 130. If an input memo is generated, the control unit 100 controls to display the memo in the set area, and stores the moving image in the storage unit 110 by recording the memo in the moving image if storing the moving image is requested. Namely, if an edit gesture is detected in the video mode for a moving image, the control unit 100 controls to displays a memo preparation window in the display unit 130 as a partial view form without switching a screen, and an input memo may be stored by recording the input memo in the moving image.

Further, in a state displaying a stored photo by accessing the storage unit 110 (for example, a photo gallery), the user may record a new memo for a remembrance of the photo or an additional memo which has not been recorded during photographing. If an edit gesture is detected in the state of displaying the photo image in the display unit 130, the control unit 100 switches the screen to a memo edit mode and sets a display area for an input touch memo by rearranging the displayed photo image. In the above state, if an input memo is generated, the control unit 100 stores an edited photo image in the storage unit 110 by composing the input memo with the displayed photo image if storing the edited photo image is requested. Namely, if an edit gesture is detected in a state of displaying a stored photo image, the control unit 100 switches to a memo edit mode, and the displayed photo image may be stored after adding a content of a user's desire.

If a menu item ‘end’ is selected after preparing the touch memo, the control unit 100 detects it through the touch panel 140, and stores the prepared touch memo in the storage unit 110 by composing with the photo. The control unit 100 may store a newly taken photo image (hereafter, original photo image) and an edited photo image, or store the original photo image with edit information. In the case of the latter, the edit information may include the size and location of a rearranged photo image, size and location of a touch memo, and content of a touch memo. When combining the photo image and the memo, the memo may be stored as a metadata form.

As described above, if the user requests for a display of a stored photo image in the state of recording a memo in the photo image, the control unit 100 controls to display the memo recorded with the photo image in the display unit 130. In the case that the memo data is stored as a metadata form, the control unit 100 may search a photo using memo information of the metadata according to a user's request for a photo image search. Namely, if the user requests for a search function related to a friend, location, and date, the control unit 100 may search a corresponding photo image by using the memo information in a metadata form.

The method of recording a memo in a photo image may also be applied to a mobile terminal not having a camera. Namely, if the mobile terminal not having a camera receives a photo image from the Internet or from an external device, an edit gesture may be generated in a state of displaying the photo image. If the edit gesture is generated, the control unit 100 switches to a memo edit mode and sets a display area for a touch memo by rearranging the displayed photo image. In the above state, if an input memo is generated, the control unit 100 composes the input memo with the photo image and stores an edited photo image in the storage unit 110. Namely, the user may store a desired memo in a photo image received from the Internet or form an external device even in a mobile terminal not having a camera.

As described above, if an edit gesture is generated in a state of displaying a photo image, an exemplary embodiment may rearrange the photo image so as to record a memo, and store the photo image by recording the memo in the rearranged photo image. Here, the edit gesture may be a touch input action, such as a finger touch, and pen touch, and a specific action may be set so as to be detected by a camera and a motion sensor (not shown). The photo image displayed in the display unit 130 may be a photo image captured by switching on a shutter in a preview mode, a photo image captured by an edit gesture in a preview mode, and a stored photo image, and moving image. When recording the memo in the photo image, the memo may be composed with the photo image, and may be stored in a metadata form in the corresponding photo image. Further, searching a photo image may be performed by using memo information such as a friend, location, and date.

Hereafter, adding a memo to a photo image selected in a preview mode and to a stored photo image will be described in more detail.

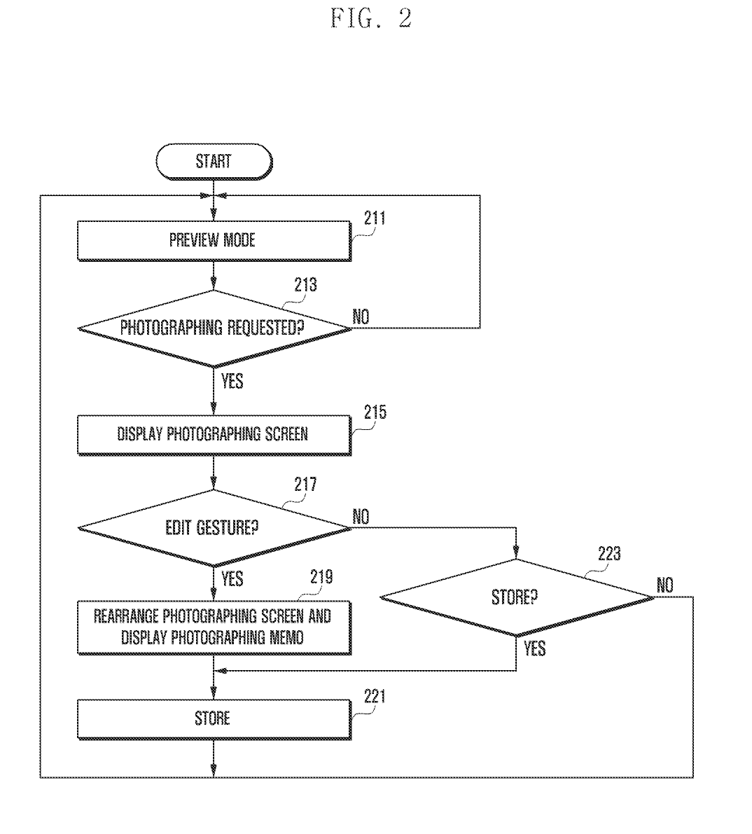

FIG. 2 is a flow chart of a procedure combining a touch memo with a photo image taken by a terminal according to another exemplary embodiment.

Referring to FIG. 2, if photographing is requested by a user, the control unit 100 executes a preview mode for capturing a photo image by activating the camera 150 and controls to display the captured photo image in the display unit 130 (211). In the above state, the control unit 100 detects a shutter switching generated by a user (213), and controls to display the captured photo image by the shutter switching as a still image in the display unit 130 (215). If the user generates an edit gesture in the above state, the control unit 100 detects it through the touch panel 140 (217), and sets a display area for a touch memo by rearranging the photo image displayed in the display unit 130 and controls to display a touch input through the touch panel 140 in the set area as a touch memo (219). If the input of the touch memo is completed, the control unit 100 controls to save an edited photo image (221). At this time, the control unit 100 may store the edited photo image with the original photo image. If a request for storing a photo is generated in a state of displaying a still image, the control unit 100 detects the request (223), and saves the photo image (221). The photo image being saved may be an original photo image.

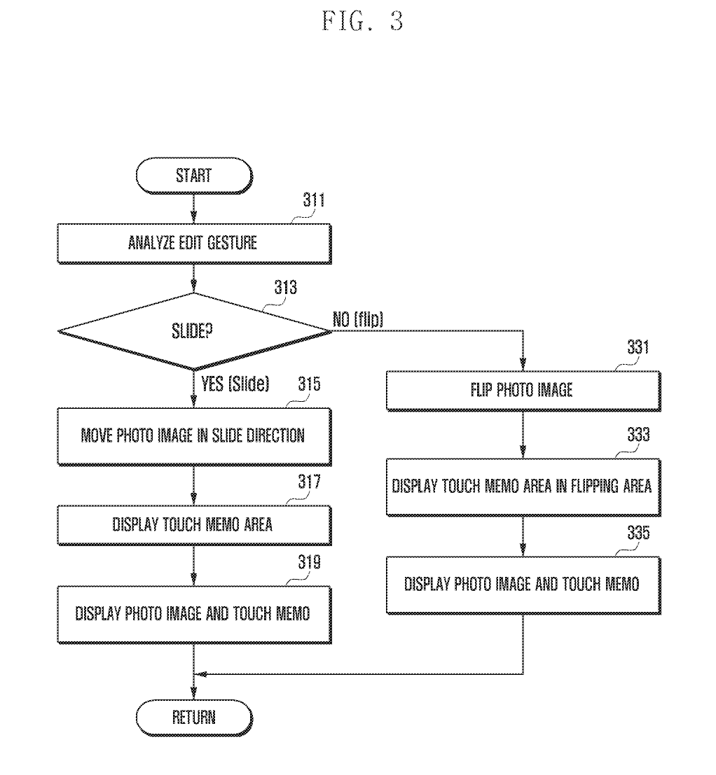

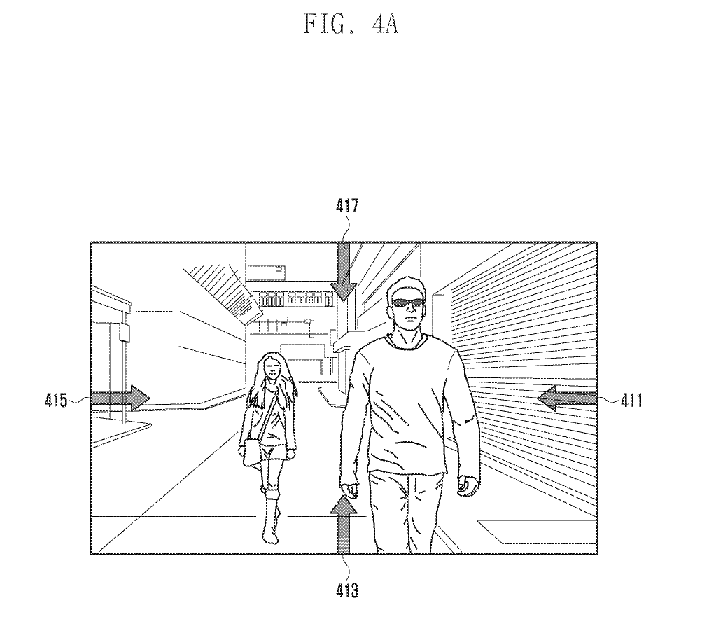

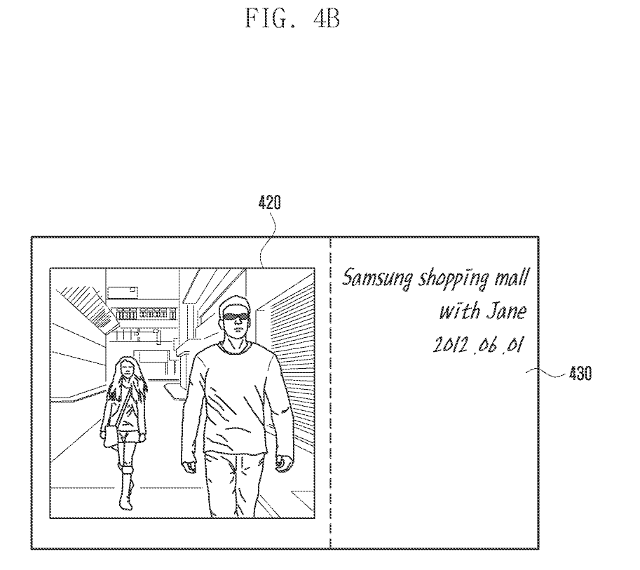

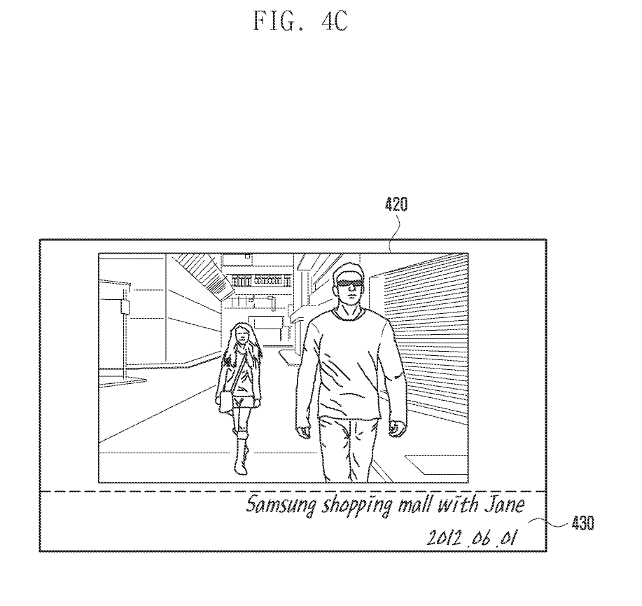

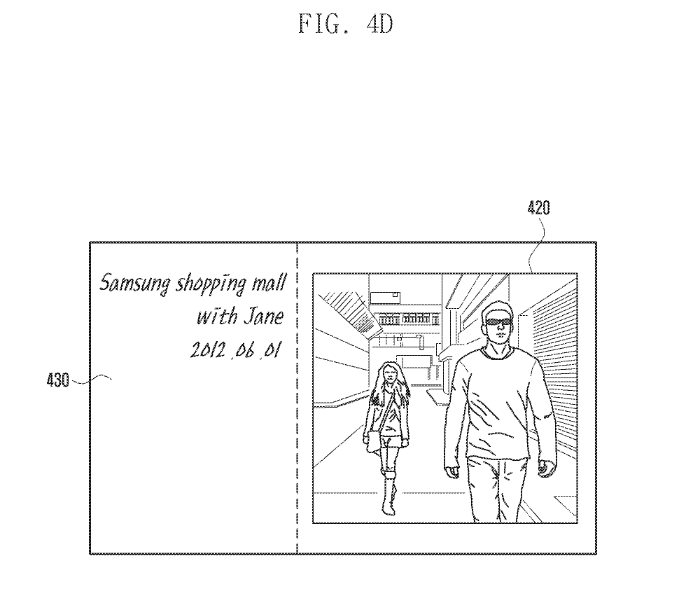

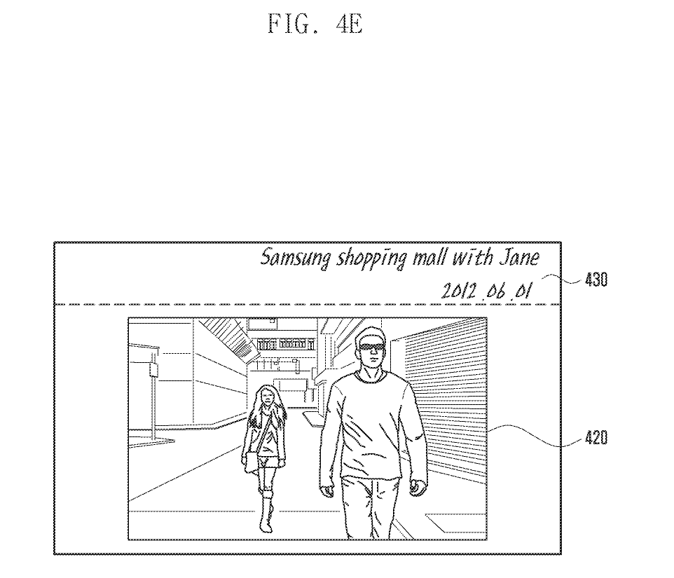

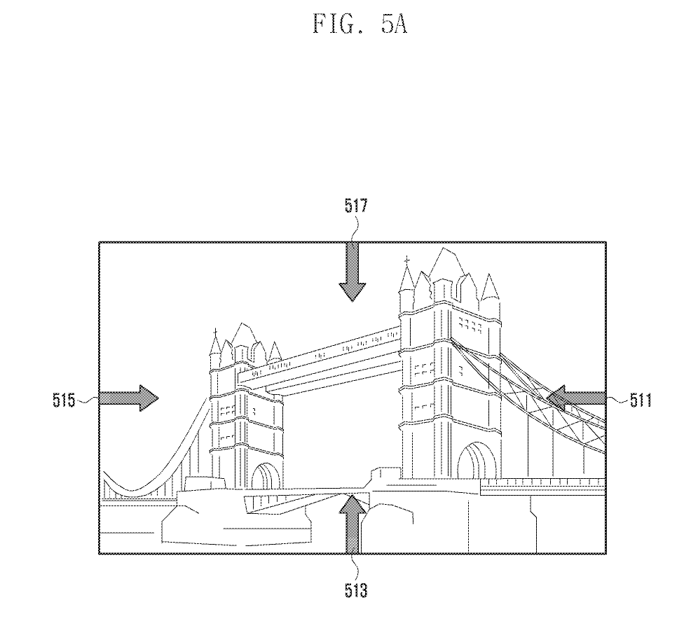

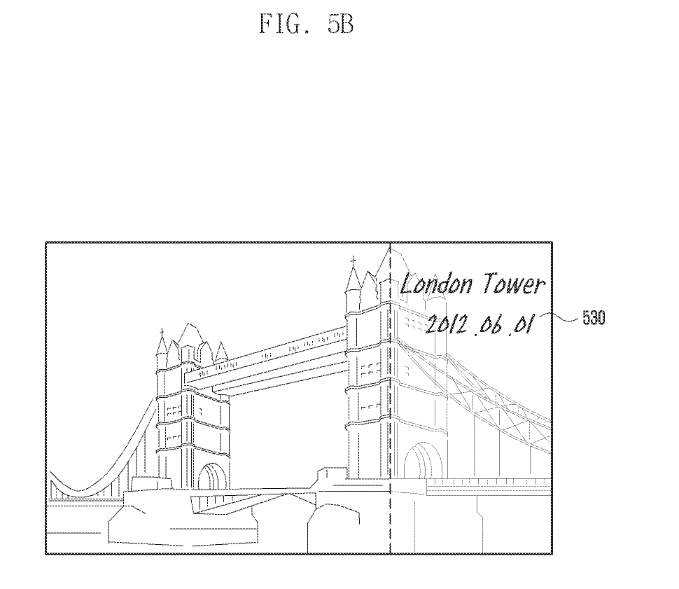

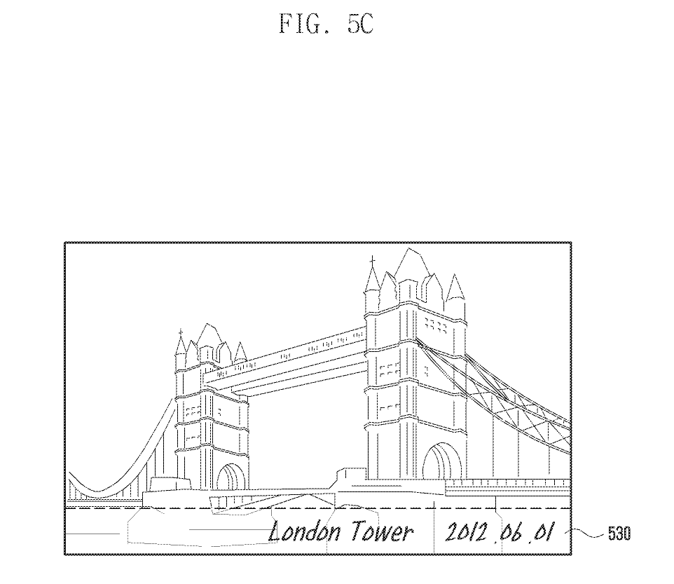

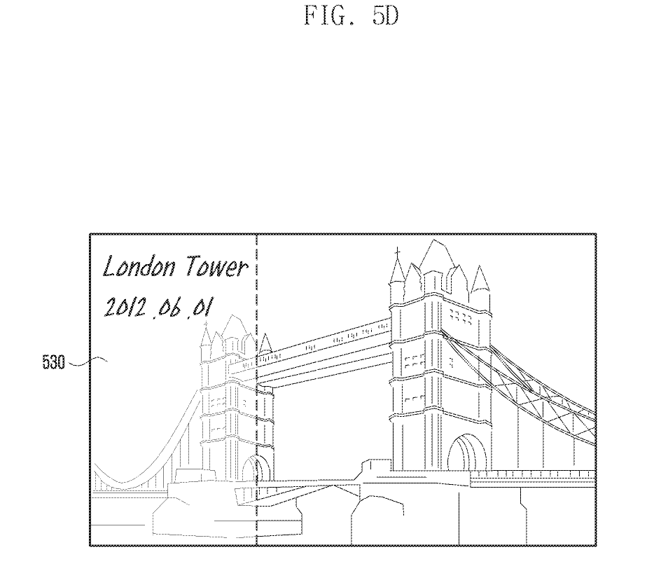

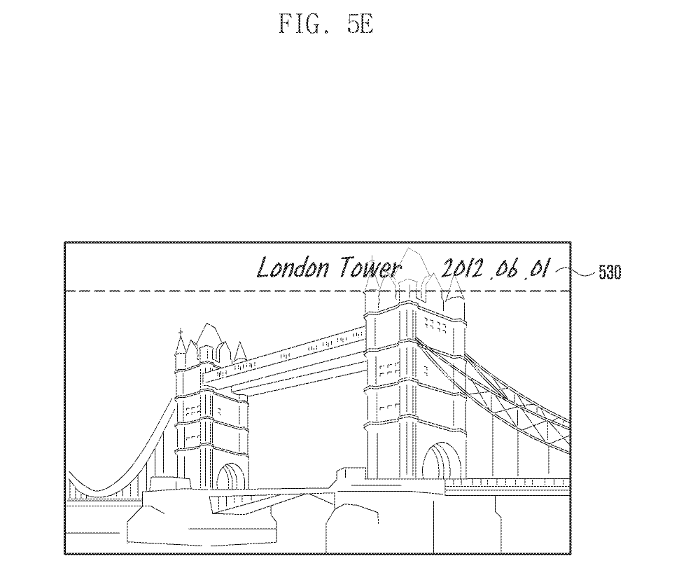

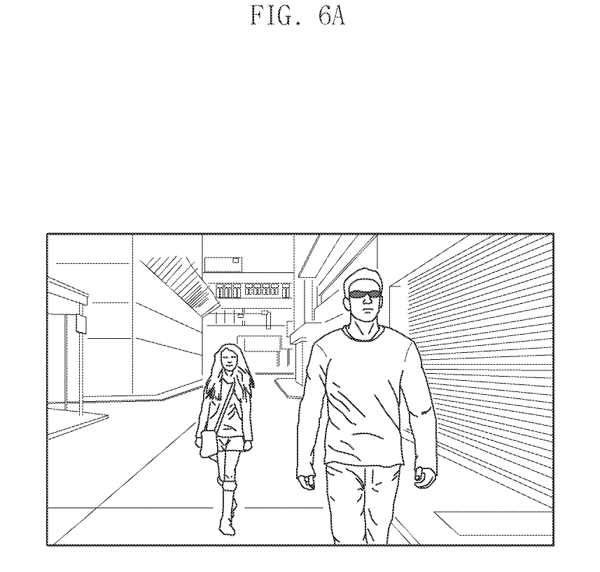

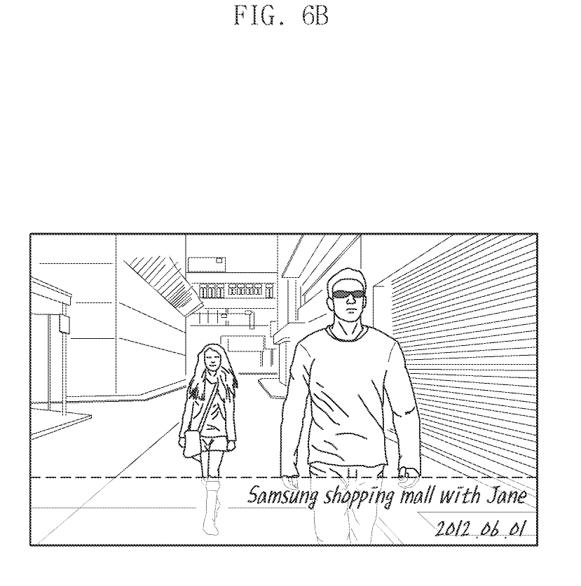

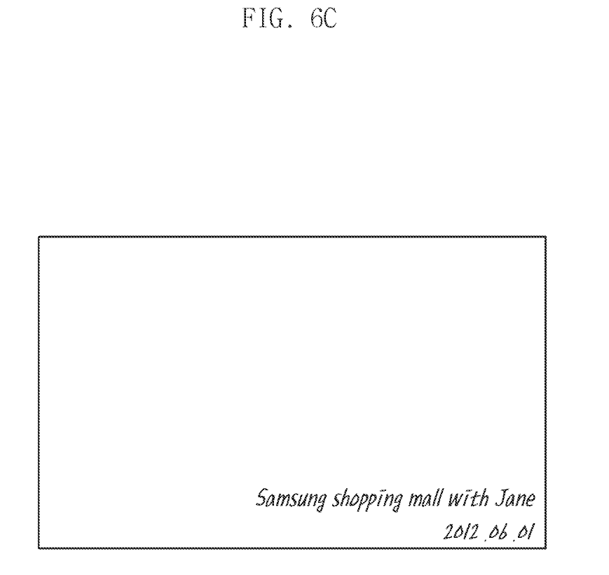

An operation of the control unit 100 for editing a photo display displayed in the display unit 130, if an edit gesture is detected in Operation 217, will be described in more detail. FIG. 3 is a flow chart of a procedure for editing a touch memo in a photo image if an edit gesture is generated according to the exemplary embodiment; FIGS. 4A to 4B are screen views illustrating examples of editing a photo image according to a slide edit gesture; FIGS. 5A to 5E are screen views illustrating alternative examples of editing a photo image according to the slide edit gesture; and FIGS. 6A to 6C are screen views illustrating examples of editing a photo image according to a flip edit gesture.

Referring to FIGS. 3 to C, the edit gesture according to an exemplary embodiment may be a touch interaction for editing a photo image, and may include a slide gesture for generating a touch memo displayed in front of the photo image and a flip gesture for generating a touch memo at the back of the photo image. If the slide gesture is detected, the control unit 100 moves horizontally the photo image displayed in the display unit 130 and adjusts the size of the photo image. A vacant space appearing according to the movement and size adjustment of the photo image may be set as a touch memo area. As an alternative method, if the slide gesture is detected, the control unit 100 may maintain the display of the photo image in the display unit 130 and set an area for preparing a touch memo for the photo image, then display the area for inputting the touch memo by adjusting the transparency (alpha-blending) of the set area. If the slide gesture is generated, the control unit 100 sets the touch memo area so that the touch memo may be prepared in front of the photo image displayed in the display unit 130.

If the flip gesture is detected, the control unit 100 controls to display the back side of the photo image by reversing the whole photo or a portion of the photo, or by folding or rolling the photo, then sets the displayed back side as a touch memo area for inputting the touch memo. At this time, the control unit 100 may ask a user's confirmation while adjusting the transparency of the touch memo area set in the display unit 130.

If an input of the edit gesture is detected in Operation 217 of FIG. 2, the control unit 100 analyzes the edit gesture (311), identifies whether the edit gesture is a slide gesture (313), moves the photo image in the direction of the slide gesture and adjusts the size of the photo image (315), and sets a vacant space appearing according to the rearrangement of the photo image as a touch memo area (317). Thereafter, if an input of a pen touch is generated, the control unit 100 controls to display an input touch memo (319).

For example, as shown in FIG. 4A, if a scroll input is generated by a user's pen touch at a specific location of the photo image in a state of displaying a photo image in the display unit 130, the control unit 100 detects the pen touch as a slide gesture, moves the photo image in the direction of the scroll, adjusts the size of the photo image according to the moving distance (movement amount), and sets the vacant space in the display unit 130 as a touch memo area according to the movement of the photo image and size of the photo image. If the user generates a pen touch input in the set touch memo area, the control unit 100 controls to display a pen touch input in the corresponding area. Here, the user may prepare photographing information (for example, a location, name of person, and mood of photographer) in a script character in the corresponding area, and the control unit 100 may store the photographing information as touch memo information in an image form.

The slide gesture may perform a scroll touch as a horizontal movement gesture, and the direction of the movement may be an upward, downward, rightward, or leftward direction. For example, as shown in FIG. 4A, if the user generates a scroll input with a pen in right-to-left direction shown by an arrow mark 411 in a state of displaying a photo image, the control unit 100 adjusts the size of the photo image while moving the photo image according to the distance of the scrolling, and may set an appearing vacant space 430 as a touch memo area according to the movement and size adjustment of the photo image as shown in FIG. 4B. If a scroll is generated in bottom-to-top direction shown by an arrow mark 413 of FIG. 4A, the control unit 100 adjusts the size of the photo image while moving the photo image upwards and sets a lower appearing vacant space as a touch memo area as shown in FIG. 4C. If a scroll is generated in right-to-left direction shown by an arrow mark 415 of FIG. 4A, the control unit 100 adjusts the size of the photo image while moving the photo image rightwards and sets an left appearing vacant space as a touch memo area as shown in FIG. 4D. If a scroll is generated in top-to-bottom direction shown by an arrow mark 417 of FIG. 4A, the control unit 100 adjusts the size of the photo image while moving the photo image downwards and sets an upper appearing vacant space as a touch memo area as shown in FIG. 4E.

If the user inputs a character by using a pen in a location set as a touch memo area in the display unit 130, the control unit 100 controls to display windows in the set touch memo area as shown in FIGS. 4B to 4E. If a request for storing the edited image is generated, the control unit 100 controls to store the photo image edited at Operation 221 of FIG. 2. When storing the edited photo image, the control unit 100 may control to store both the original image and the edited photo image according to the set condition, and a method of storing the touch memo may be performed by combining with the photo image adjusted in the size and location, or by storing edit information only. Here, the edit information may be stored in an image form combined with the rearranged photo image (i.e. the photo image may be adjusted in size and location) and the touch memo, or in an image form combined with the location and size information (i.e. the rearranged photo image and the touch memo area) and the touch memo.

If the slide gesture is generated, an edited photo image may be prepared in the same method as shown in FIGS. 5A to 5B. FIGS. 5A to 5E illustrate examples of setting a touch memo area in a specific location of the photo image in a state of maintaining the size and location of the photo image and displaying the touch memo input in the set touch memo area by adjusting the transparency of the content of the input touch memo. For this, if the user generates a scroll input with a pen in right-to-left direction shown by an arrow mark 511 of FIG. 5A in a state of displaying the photo image, the control unit 100 sets a touch memo area as shown in FIG. 5B according to the distance of scrolling. If a scroll input is generated in bottom-to-top direction shown by an arrow mark 513 of FIG. 5A, the lower portion of the photo image is set as a touch memo area as shown in FIG. 5C. If a scroll input is generated in left-to-right direction shown by an arrow mark 515 of FIG. 5A, the left portion of the photo image is set as a touch memo area as shown in FIG. 5D. If a scroll input is generated in top-to-bottom direction as shown by an arrow mark 517 of FIG. 5A, the upper portion of the photo image is set as a touch memo area as shown in FIG. 5E. Here, the control unit 100 may adjust the transparency of the portion set as a touch memo area by alpha-blending in the photo image displayed in the display unit 130.

If the user inputs characters with a pen in the touch memo area set in the display unit 130, the control unit 100 controls to display the characters in the set touch memo area as shown in FIGS. 5B to 5E. If a request for storing an edited image is generated, the control unit 100 controls to store the photo image edited in Operation 221 of FIG. 2. When storing the edited photo image, the control unit 100 may control to store an original photo image and the edited photo image according to a setting condition. Here, the edited photo image may include location information of the set touch memo area and the content of the touch memo.

If the edit gesture is a flip gesture, the control unit 100 detects it at Operation 313 of FIG. 3 and flips the photo image according to the flip gesture at Operation 331 of FIG. 3. Here, the flip means reversing, folding, or rolling the photo image. After flipping the photo image, the control unit 100 sets a portion flipped at Operation 333 of FIG. 3 as a touch memo area, and controls the display unit 130 to show the touch memo area to the user by adjusting the transparency of the portion set as the touch memo area. Thereafter, if the user generates a pen touch input in the touch memo area displayed in the display unit 130, the control unit 100 detects the pen touch input through the touch panel 140 at Operation 335 of FIG. 3, and controls to display the corresponding area in the display unit 130.

For example, as shown in FIG. 6A, if a specific set gesture is generated in a state of displaying a photo image in the display unit 130, the control unit 100 detects it as a flip gesture through the touch panel 140. The flip gesture may be set by a pen touch input generated in a specific location of the display unit 130 (for example, a corner of the display unit), and may be set also by a rotation touch of the pen at a specific location of the display unit 130 (for example, an edge of the display unit). In this case, the pen touch generated at an edge of the display unit 130 may be identified as a flip gesture flipping the photo image at the corresponding edge, and if the rotation touch of the pen is generated, the rotation touch may be identified as a flip gesture flipping the photo image towards the location where the flip gesture is generated. Accordingly, if the flip gesture is generated, the control unit 100 flips the photo image of FIG. 6A as shown by screen portion 610 of FIG. 6B, and sets the flipped portion 610 as a touch memo area. Here, the control unit 100 may control to display the flipped portion 610 by adjusting the transparency of the flipped portion 610 so as to be distinguished from the other part of the photo image, and the user may thereby identify the set touch memo area.

If the user inputs characters with a pen in the location set as a touch memo area in the display unit 130, the control unit 100 controls to display the input characters in the set touch memo area. As described above, if a request for storing the edited photo image is generated, the control unit 100 controls to store the photo image edited an Operation 221 of FIG. 2. When storing the edited photo image, the control unit 100 may store both the original photo image and the edited photo image according to a setting condition. Here, the edited image may include location information of the set touch memo area and the content of the touch memo. Further, the content of the touch memo may be designed to be located at the back side of the photo image in printing a photo image. Accordingly, in a print mode, the control unit 100 controls to print the touch memo by rotating the photo image to 180 degree as shown in FIG. 6C.

For example, as shown in FIG. 6A, if a flip gesture is generated in a state of displaying a photo image in the display unit 130, the control unit 100 sets a touch memo area on the photo image and controls to display a pen touch input in the set touch memo area. When storing the photo image, the control unit 100 controls to store the original photo image, and the content and location information of the touch memo. In the above state, if printing the photo image is requested, the control unit 100 controls to print the photo image of FIG. 6A at the front side of a photo and the touch memo at the back side of the photo as shown in FIG. 6C.

As described above, the terminal according to the exemplary embodiment displays a photo image taken by switching on a shutter (if capturing a photo is requested) in the display unit 130 as a still image in a preview mode of activating a camera, and sets a touch memo area on the photo image if an edit gesture is generated. Here, the touch memo area may be set at the front side of the photo image or at the back side of the photo. In the case of setting the touch memo area at the front side of the photo, the control unit 100 sets a vacant area for inputting a touch memo as a touch memo area by adjusting the location and size of the photo image according to a planar movement gesture (for example, scroll gesture), or sets an area for inputting a touch memo on the photo image as a touch memo area by alpha blending (i.e. adjustment of the transparency). In the case of setting the touch memo area at the back side of the photo image, a specific action (for example, touching a corner of the display unit with a pen and generating a rotation touch at an edge of the display unit) is identified as a flip gesture, and the touch memo area may be set by flipping, folding, or rolling the photo image.

If a user's pen touch input is detected, the control unit 100 may generate and store a letter image by combining the photo image with input pen memo information.

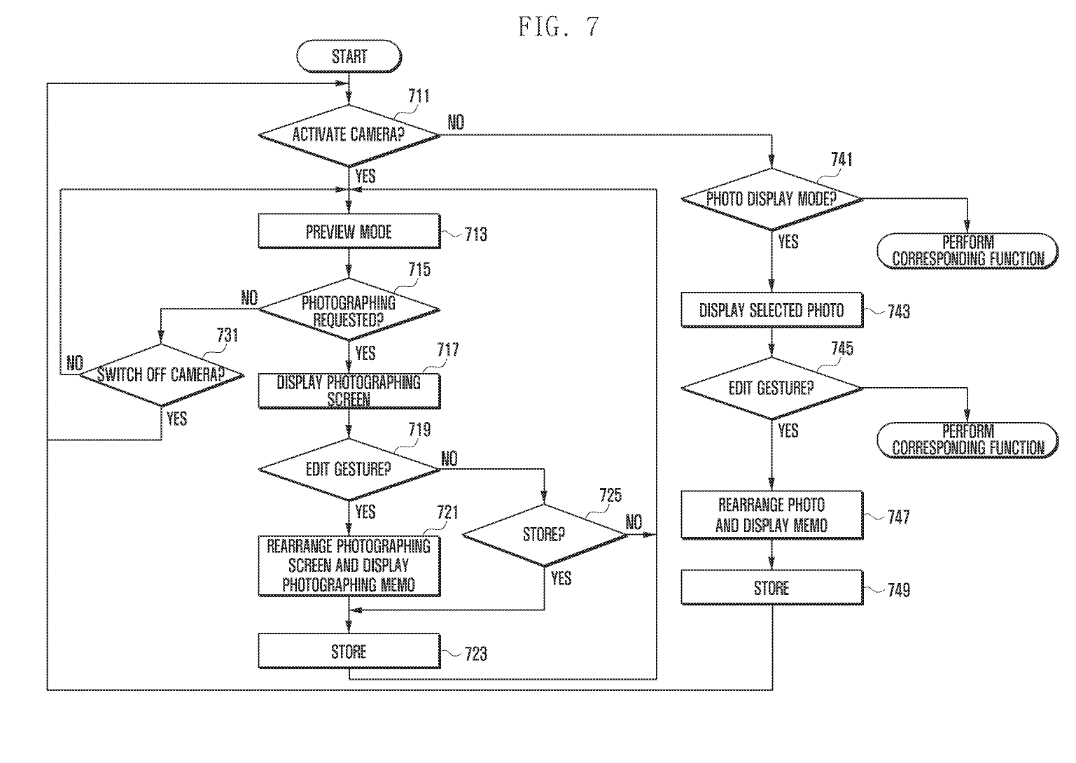

FIG. 7 is a flow chart of another procedure combining a touch memo with a photo image taken by a terminal according to an exemplary embodiment.

Referring to FIG. 7, if activating a camera is requested by the user, the control unit 100 detects it (711), controls the camera 150 to capture a photo image (713), and performs a preview mode for displaying the captured photo image in the display unit 130. In the above state, if the user switches on the shutter, the control unit 100 detects it (715), and controls to display the photo image captured at the time of switching on the shutter (717) as a still image in the display unit 130. In the above state, if the user inputs an edit gesture, the control unit 100 detects it through the touch panel 140 (719), sets an area for displaying a touch memo by rearranging the photo image displayed in the display unit 130 (721), and controls to display the touch input through the touch panel 140 in the set area as a touch memo. Here, setting of the touch memo and preparation of a touch memo may be performed in the same procedure as shown in FIG. 3.

If the input of the touch memo is completed, the control unit 100 controls to store the edited photo image (723). Here, the control unit 100 may control to store both the edited photo image and the original photo image. Storing the edited image and the original image may be performed in the same method described before. The edited image may be a composite image including a touch memo, or a composite image including the touch memo and touch memo information. If a request for storing a photo image in a state of displaying the still image, the control unit 100 detects it (725) and controls to store the photo image (723). Here, the stored photo image may be the original photo image.

Thereafter, if the user generates a command of deactivating the camera 150, the control unit 100 detects it and switches off the camera 150 (731).

As described the above, a photo captured by the camera 150 is stored in the storage unit 110. A photo image stored in the storage unit 110 may be edited by using a pen. Namely, the user may select a photo image stored in the storage unit 110 after photographing, and edit the photo image by setting a memo area in the displayed photo image. If a photo is selected by the user, the control unit 100 detects it (741), and controls to display the selected photo in the display unit 130 (743). If an edit gesture is generated in a state of displaying the photo image, the control unit 100 detects it (745), sets a touch memo area by rearranging the displayed photo image (747), and controls to display a pen touch input in the set touch memo area. The operation of Operation 745 may be performed in the same method as shown in FIG. 3, and the edited photo image may be generated in the same method as shown in FIGS. 4A to 6C.

As described above, a terminal according to an exemplary embodiment includes a camera 150 and a touch panel 140 for detecting a pen touch input. If an edit gesture is detected in a state of displaying a photo image, an area for displaying a touch memo is set in the photo image. If the pen touch input is detected through the touch panel 140, an edited photo images is generated by displaying the touch memo in the set area. Thereafter, the terminal stores the edited image in a storage unit 110. The terminal may generate a touch memo and combine it with a photo image captured in photographing or with a stored photo image. The touch memo may be input in a script or text form as a record of a photographing note.

Although exemplary embodiments have been described in detail hereinabove, it should be understood that many variations and modifications of the basic inventive concept described herein will still fall within the spirit and scope of the present invention as defined in the appended claims.

What is claimed is:

1. A method for processing an image in a terminal, the method comprising:
displaying the image;
setting a memo area by rearranging the displayed image;
generating an edited image by displaying an input in the memo area; and
storing the edited image by combining with a memo.

2. The method of claim 1, wherein, in the displaying the image, the image comprises an image displayed in a preview mode while photographing.

3. The method of claim 2, wherein the setting the memo area comprises:
moving the image in a direction of a slide gesture if the slide gesture is detected as an edit gesture; and
replacing the area the image is moved from with the memo area.

4. The method of claim 3, wherein the slide gesture is a scroll touch by a pen, and the movement direction of the scroll touch is one from among upward, downward, leftward, and rightward directions.

5. The method of claim 4, wherein size and location of the moved image are adjusted.

6. The method of claim 5, wherein the storing the edited image comprises storing an original image and the edited image.

7. The method of claim 2, wherein the displaying the image comprises:
displaying a movement direction of a slide gesture if the slide gesture is detected as an edit gesture;
displaying the memo area by adjusting a transparency of a setting area according to the movement direction and distance of the slide gesture; and
displaying the input in the memo.

8. The method of claim 7, wherein the slide gesture is a scroll touch by a pen, and the direction of the scroll touch is one from among upward, downward, leftward, and rightward directions.

9. The method of claim 8, wherein the storing the edited image comprises storing an original image, a location of the memo area, and the memo together.

10. The method of claim 2, wherein the setting the memo area comprises:
flipping the image displayed in a location of a flip gesture if the flip gesture is detected as an edit gesture; and
setting the memo area by adjusting a transparency of the area of the flipped image.

11. The method of claim 10, wherein the flip gesture is generated by the pen, and the flipping the image is an operation of reversing or folding the image.

12. The method of claim 11, wherein the storing an edited image comprises storing an original image, a location of the memo area, and the memo.

13. An apparatus for processing an image in a terminal, the apparatus comprising:
a camera which obtains the image;
a storage which stores the image;
a touch panel which detects a touch input;
a controller configured to control a display of the image obtained by the camera, set a touch memo area by rearranging the displayed image if an edit gesture is detected in the touch panel, display the touch input in the touch memo area, and store the image in the storage by combining the image with a touch memo; and
a display which displays the image and the touch memo under the control of the controller.

14. The apparatus of claim 13, wherein the displayed image comprises an image displayed in a preview mode while photographing.

15. The apparatus of claim 14, wherein the controller controls to move the image displayed in the display if a slide gesture is detected as an edit gesture, controls to set an area of the moved image as the touch memo area, and controls to display the touch input through the touch panel in the touch memo area.

16. The apparatus of claim 15, wherein the controller controls to display the touch memo area by adjusting a transparency of the set area according to a movement direction and distance of the slide gesture if the slide gesture is detected as an edit gesture, and controls to display the touch input as a touch memo in the touch memo area.

17. The apparatus of claim 14, wherein the controller controls to flip the image displayed in a location of a flip gesture if the flip gesture is detected as an edit gesture, controls to set an area of the flipped image as a touch memo area by adjusting the transparency of the area of the flipped image, and controls to display the touch input in the touch memo area.

18. The method of claim 1, wherein the image comprises a photo image and the input comprises a pen touch input.

19. The apparatus of claim 13, wherein the touch input is a pen touch input.

20. The apparatus of claim 13, wherein the image comprises a photo image.
